(19) United States
(12) Patent Application Publication
(10) Pub. No.: US 2004/0032174 A1
(43) Pub. Date: Feb. 19, 2004

(54) Motor

(76) Inventors: Young Gill Yeo, Inchon (KR); Jin Goon Yoon, Suwon-City (KR)

Correspondence Address: PERKINS COIE LLP, P.O. BOX 2168, MENLO PARK, CA, 94026, US

(21) Appl. No.: 10/285,781

(22) Filed: Oct. 31, 2002

(30) Foreign Application Priority Data
Aug. 14, 2002 (KR) 20-2002-0024345
Oct. 14, 2002 (KR) 2002-0062431

(51) Int. Cl. H02K 5/16; H02K 7/08

(52) U.S. Cl. 310/90

(57) ABSTRACT

A motor, with a drive shaft, a driven shaft, and a reduction gear mechanism transmitting a rotating force of the drive shaft to the driven shaft while lowering a rotating speed to a predetermined level required by the driven shaft, is disclosed. In the motor, two needle bearings are set in a motor housing to rotatably support the driven shaft. Two thrust washers, each having one or more lubricating holes, are set in the motor housing to prevent a positional displacement of the needle bearings during a rotation of the driven shaft. Due to such thrust washers, frictional interference of the needle bearings with support rings caused by a positional displacement of the needle bearings is prevented. Since the thrust washers have the lubricating holes, lubricant contained in the motor housing smoothly flows to the frictional contact areas between the needle bearings and the driven shaft, thus continuously forming effective lubricant layers between the bearing rollers and the driven shaft. It is thus possible to prevent damage or breakage of the driven shaft and/or the needle bearings due to frictional contact, and reduce repair and maintenance costs of the motor, and improve the operational reliability of the motor.

### BACKGROUND OF THE INVENTION

1. Field of the Invention

The present invention relates, in general, to motors and, more particularly, to a motor, in which a driven shaft is set in a motor housing such that the driven shaft is projected at an end thereof outside the motor housing and is connected to a drive shaft through a reduction gear mechanism so as to be rotated in conjunction with the drive shaft, and a frictional contact area of the driven shaft and the motor housing is included in an effective sphere of lubricant, so that it is possible to minimize frictional contact between the driven shaft and needle bearings rotatably supporting the driven shaft in the motor housing at the frictional contact area, thus enhancing durability and lengthening expected life span of the motor.

2. Description of the Prior Art

As well known to those skilled in the art, motors, also known as electric motors, are machines that convert electric energy into mechanical energy by utilizing forces produced by magnetic fields on current-carrying conductors. The motors are classified into DC motors and AC motors in accordance with electric power sources, and the AC motors are classified into single-phase AC motors and three-phase AC motors. The three-phase AC motors are used as large-capacity motors having capacities typically ranging from about 1 kW to several thousand kW, and rarely exceeding ten thousand kW. The single-phase AC motors are used as small-capacity motors having capacities of several hundred W or less.

Even though the motors are classified into DC motors and AC motors in accordance with their electric power sources, there is no difference in operational theory between the two types of motors. That is, in a motor, regardless of its type, a conductor is placed in a magnetic field such that the conductor crosses the magnetic field at a right angle. When an electric current flows in the conductor, an electromotive force is produced by motion of the conductor through the magnetic field so as to cut across the magnetic flux, and such a phenomenon is known as “electromagnetic induction”. In such a case, the electromotive force produced by the electromagnetic induction is in proportion to the product of the intensity of magnetic field, the intensity of electric current, and the length of the conductor.

The motors also have been classified into several types, in accordance with their uses. There have been used geared motors comprising drive and driven parts, with a reduction gear mechanism connecting the drive and driven parts to each other. When electricity is applied to the drive part of such a geared motor, a coil of the drive part is electro-magnetized, so that the drive shaft of the drive part is rotated. The rotating force of the drive shaft is transmitted to a driven shaft of the driven part through the reduction gear mechanism. In such a case, the reduction gear mechanism transmits the rotating force from the drive shaft to the driven shaft while lowering the rotating speed, thus rotating the driven shaft at a lowered speed.

In such a geared motor, the driven shaft is installed in a motor housing as follows. That is, a part of the driven shaft is rotatably supported in the motor housing by both needle bearings and support rings, such as E-rings, at two or more positions, and the remaining part of the driven shaft is projected to the outside of the motor housing.

Lubricant, such as grease, is contained in the motor housing at predetermined areas around the reduction gear mechanism so as to allow the frictional contact elements of the motor to smoothly move relative to each other.

However, the needle bearings installed at intermediate portions of the driven shaft may be displaced to interfere with the support rings during a rotation of the driven shaft. In order to prevent such a positional displacement of the needle bearings during a shaft's rotation, thrust washers are mounted at positions around the needle bearings. However, the thrust washers undesirably disturb smooth flow of lubricant to the frictional contact areas between the driven shaft and the needle bearings, so that the lubricant layer formed between the bearing rollers and the driven shaft is oxidized or thermally degraded after a long time of operating the motor. The needle bearings in such a state come into severe frictional contact with the driven shaft, so that the driven shaft and/or the needle bearings become severely damaged or broken, resulting in forcing a user to repair or change the damaged or broken elements and shortening the expected life span of the motor.

### SUMMARY OF THE INVENTION

Accordingly, the present invention has been made keeping in mind the above problems occurring in the prior art, and an object of the present invention is to provide a motor, in which thrust washers each having a lubricating hole are installed at a driven shaft along with support rings to allow smooth flow of lubricant to the frictional contact areas between the driven shaft and needle bearings, and which thus prevents severe frictional contact and frictional abrasion of the bearing rollers and the driven shaft, and which prevents damage or breakage of the bearing rollers and the driven shaft, thus being operated for a lengthened life span.

In order to accomplish the above objects, the present invention provides a motor comprising a drive shaft, a driven shaft, and a reduction gear mechanism transmitting a rotating force of the drive shaft to the driven shaft while lowering a rotating speed to a predetermined level required by the driven shaft, wherein the driven shaft is set in a motor housing such that the driven shaft engages with the reduction gear mechanism and is projected at an end thereof outside the motor housing, a needle bearing is set in the motor housing such that the needle bearing supports a rotation of the driven shaft, and a support ring and a thrust washer are fitted over the driven shaft and are set in the motor housing to rotatably support the driven shaft in the housing, the thrust washer having a lubricating hole allowing lubricant to flow to a frictional contact area between the driven shaft and the needle bearing.

In an embodiment of the invention, the lubricating hole of the thrust washer comprises one or more holes which are formed along an annular body of the thrust washer to individually form a closed figure between inner and outer circumferential edges of the washer.

In another embodiment, the lubricating hole of the thrust washer comprises one or more holes which are formed along an inner circumferential edge of the thrust washer to individually form an open figure communicating with a central opening of the washer.

In a further embodiment, the thrust washer has a lubricating groove that contains lubricant and allows the lubricating holes to communicate with each other through the lubricating groove.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a side view of a motor having a holed thrust washer in accordance with the present invention;

FIG. 2 is a sectional view showing the construction of the motor of FIG. 1;

FIG. 3a is a front view of a thrust washer, set in the motor of FIG. 2, in accordance with a primary embodiment of the present invention;

FIG. 3b is a front view of a thrust washer, set in the motor of FIG. 2, in accordance with a second embodiment of the present invention;

FIG. 4a is a front view of a thrust washer, set in the motor of FIG. 2, in accordance with a third embodiment of the present invention; and

FIG. 4b is a front view of a thrust washer, set in the motor of FIG. 2, in accordance with a fourth embodiment of the present invention.

### DETAILED DESCRIPTION OF THE INVENTION

Reference should now be made to the drawings, in which the same reference numerals are used throughout the different drawings to designate the same or similar components.

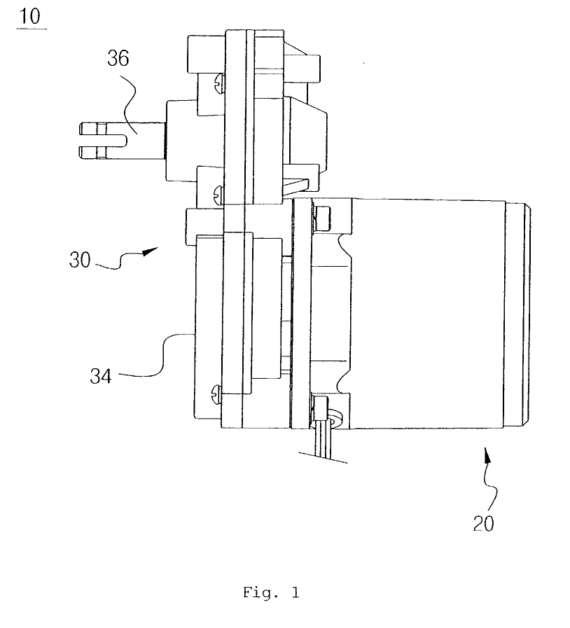

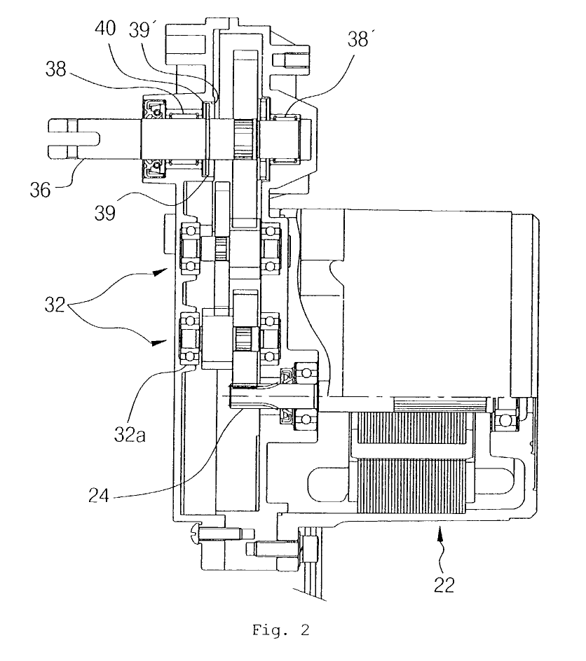

FIG. 1 is a side view of a geared motor having a holed thrust washer in accordance with the present invention. FIG. 2 is a sectional view showing the construction of the motor. As shown in the drawings, the geared motor 10 of the present invention comprises a drive part 20 and a driven part 30. The drive part 20 comprises a coil 22 and a drive shaft 24. When the motor 10 is turned on by electricity, the coil 22 generates electromagnetic force, thus rotating the drive shaft 24. The driven part 30 comprises a driven shaft 36, and a reduction gear mechanism 32 that connects the driven shaft 36 to the drive shaft 24. The reduction gear mechanism 32 thus transmits a rotating force of the drive shaft 24 to the driven shaft 36 while lowering the rotating speed to a predetermined level required by the driven shaft 36.

Lubricant, such as grease, is contained in the motor housing 34 at predetermined areas around the driven part 30 so as to lubricate the junctions of frictional contact elements constituting the motor 10, thus minimizing frictional contact between the elements and allowing the elements to smoothly move relative to each other.

The driven shaft 36 is rotatably set in the motor housing 34 such that a first end of the driven shaft 36 is projected outside the motor housing 34. Two needle bearings 38 and 38′ are set in the motor housing 34 such that the needle bearings 38 and 38′ support a rotation of the driven shaft 36 at two positions around the middle portion and second end of the shaft 36 within the housing 34.

Two support rings 39, such as E-rings, are fitted over the driven shaft 36, and are seated in two seats 39′ formed in the motor housing 34 at two positions around the two needle bearings 38 and 38′, thus preventing the driven shaft 36 from an undesired removal of the driven shaft 36 from the housing 34.

The reduction gear mechanism 32 comprising a gear train is arranged between the drive and driven shafts 24 and 36 so as to connect the driven shaft 36 to the drive shaft 24. The reduction gear mechanism 32 thus transmits a rotating force of the drive shaft 24 to the driven shaft 36 while lowering the rotating speed to a predetermined level required by the driven shaft 36. The reduction gear mechanism 32 is rotatably set in the motor housing 34 by using a plurality of ball bearings 32a.

When the motor 10 is repeatedly used over a lengthy period of time or impacted by external shock, the needle bearings 38 and 38′ may be undesirably displaced from their original positions to come into frictional contact with the support rings 39. In order to prevent the needle bearings 38 and 38′ from such a displacement, two thrust washers 40 are set in the two seats 39′ of the motor housing 34 such, that a needle bearing 38, 38′ and a thrust washer 40 are sequentially arranged in each of the two seats 39′. Each thrust washer 40 has one or more lubricating holes that allow lubricant to flow to frictional contact areas between the rollers of the needle bearings 38 and 38′ and the driven shaft 36, thus continuously forming effective lubricant layers between the bearing rollers and the driven shaft 36. It is thus possible to prevent damage or breakage of the driven shaft 36 and/or the needle bearings due to frictional contact.

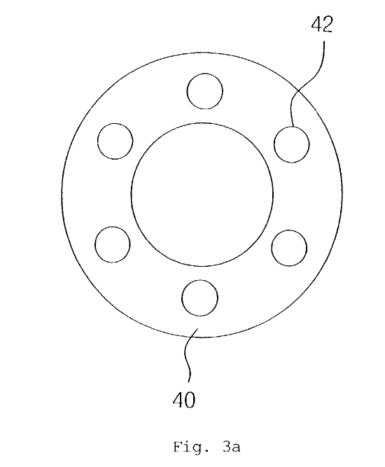

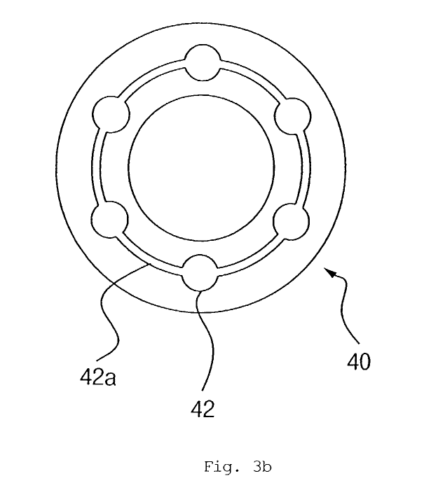

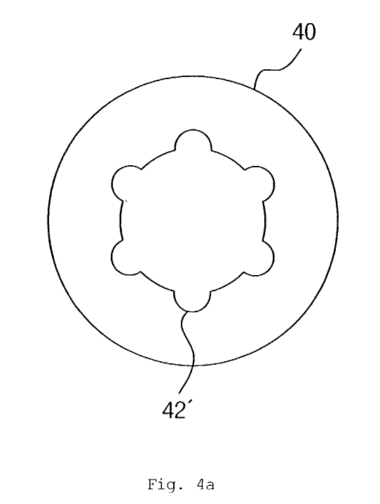

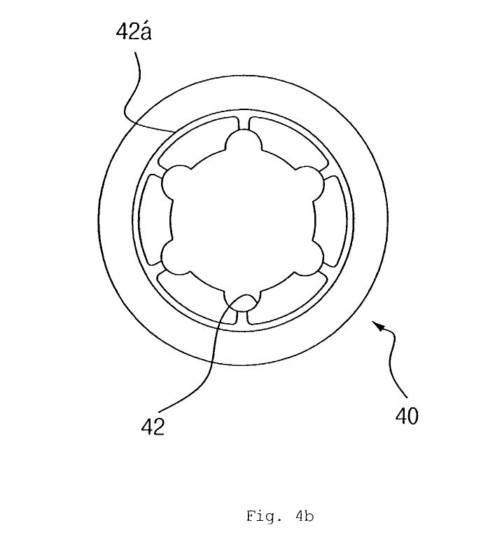

In a primary embodiment of the present invention, the lubricating hole of each thrust washer 40 comprises one or more holes 42 which are formed along an annular body of the thrust washer 40 to individually form a closed circular figure between inner and outer circumferential edges of the washer 40, as shown in FIG. 3a. In a second embodiment of FIG. 3b, a lubricating groove 42a is formed on the annular body of the thrust washer 40 such that the lubricating holes 42 communicate with each other through the lubricating groove 42a. In a third embodiment of FIG. 4a, the lubricating hole of the thrust washer 40 comprises one or more holes 42′ which are formed long an inner circumferential edge of the thrust washer 40 to individually form an open semicircular figure communicating ith a central opening of the washer 40. In a fourth embodiment of FIG. 4b, a lubricating groove 42′a is formed on the annular body of the thrust washer 40 such that the lubricating groove 42′a defines an annular shape and allows the lubricating holes 42′ to communicate with each other through the lubricating groove 42′a.

The lubricating groove 42a, 42′a of each thrust washer 40 contains a predetermined amount of lubricant, so that when there occurs a problem in normal feeding of lubricant to the frictional contact areas between the needle bearings 38 and 38′ and the driven shaft 35 through the lubricating holes 42, 42′, the lubricating groove 42a, 42′a feeds its lubricant to the lubricating holes 42, 42′, thus allowing lubricant to flow to the frictional contact areas.

The geared motor 10 according to the present invention is operated as follows.

When electricity is applied to the drive part of the geared motor 10, the coil 22 of the drive part 20 is electro-magnetized, so that the drive shaft 24 of the drive part 20 is rotated. The rotating force of the drive shaft 24 is transmitted to the driven shaft 36 of the driven part 30 through the reduction gear mechanism 32. During the operation of the geared motor 10, lubricant contained in the motor housing 34 is fed through the lubricating holes 42, 42′ of the thrust washers 40 to the frictional contact areas between the driven shaft 36 and the needle bearings 38 and 38′ that rotatably support the driven shaft 36 in the motor housing 34, so that the frictional contact areas are effectively lubricated.

As described above, the present invention provides a motor comprising a drive shaft, a driven shaft, and a reduction gear mechanism transmitting a rotating force of the drive shaft to the driven shaft while lowering a rotating speed to a predetermined level required by the driven shaft. In the motor, needle bearings are set in a motor housing so as to rotatably support the driven shaft. Thrust washers, each having one or more lubricating holes, are set in the motor housing so as to prevent a positional displacement of the needle bearings during a rotation of the driven shaft. Due to the thrust washers, the needle bearings are not displaced, and frictional interference of the needle bearings with support rings caused by such a positional displacement of the needle bearings is prevented. Since the thrust washers have the lubricating holes, lubricant contained in the motor housing smoothly flows to the frictional contact areas between the needle bearings and the driven shaft, thereby continuously forming effective lubricant layers between the bearing rollers and the driven shaft. It is thus possible to prevent damage or breakage of the driven shaft and/or the needle bearings due to frictional contact, and reduce repair and maintenance costs of the motor, and improve the operational reliability of the motor.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A motor comprising a drive shaft, a driven shaft, and a reduction gear mechanism transmitting a rotating force of the drive shaft to the driveh shaft while lowering a rotating speed to a predetermined level required by said driven shaft, wherein said driven shaft is set in a motor housing such that the driven shaft engages with the reduction gear mechanism and is projected at an end thereof outside the motor housing;
a needle bearing is set in said motor housing such that the needle bearing supports a rotation of the driven shaft; and
a support ring and a thrust washer are fitted over said driven shaft and are set in the motor housing to rotatably support the driven shaft in said housing, said thrust washer having a lubricating hole allowing lubricant to flow to a frictional contact area between the driven shaft and the needle bearing.

2. The motor according to claim 1, wherein said lubricating hole of the thrust washer comprises one or more holes which are formed along an annular body of the thrust washer to individually form a closed figure between inner and outer circumferential edges of the washer.

3. The motor according to claim 1, wherein said lubricating hole of the thrust washer comprises one or more holes which are formed along an inner circumferential edge of the thrust washer to individually form an open figure communicating with a central opening of the washer.

4. The motor according to any one of claims 1 to 3, wherein said thrust washer has a lubricating groove which contains lubricant and allows the lubricating holes to communicate with each other through the lubricating groove.
